(19) United States
(12) Patent Application Publication
(10) Pub. No.: US 2023/0135615 A1
(43) Pub. Date: May 4, 2023

(54) MAC-BASED ROUTING

(71) Applicant: Arista Networks, Inc., Santa Clara, CA (US)

(72) Inventors: David SNOWDON, Sydney (AU); Andrew John Edward BROWN, Sydney (AU); Hugh Weber HOLBROOK, Palo Alto, CA (US)

(21) Appl. No.: 17/514,134

(22) Filed: Oct. 29, 2021

(51) Int. Cl. H04L 12/721; H04L 12/741

(52) U.S. Cl. CPC H04L 45/66; H04L 45/745

(57) ABSTRACT

A network device is configured to route an ingress packet based on its L2 header. In some configurations the ingress packet is routed based only on the destination MAC (DMAC) address in the L2 header, which allows the network device to begin routing as soon as the DMAC is received. The DMAC can be used in a table look up operation to identify routing actions for a nexthop. An egress packet is produced from the ingress packet using the routing actions. The egress packet is then sent on an egress port specified in the routing actions.

### BACKGROUND

When a packet is sent by a host to a network device, the network device can forward the packet.

Network devices allow host machines to communicate with each other by forwarding packets received from one host to another host. When a network device forwards a packet within the same sub-net (e.g., 1.0.0.0/8), the network device is performing an operation commonly referred to as “bridging.” In a typical bridging operation, the network device first checks to see if it was the intended recipient of the packet. The network device does this by matching the destination media access control (DMAC) address contained in the packet with the MAC address of the network device. If there is no match, the network device can drop the packet. The network device then identifies the egress port based only on information contained in the Media Access Control (MAC) header of the ingress packet and does not modify the ingress packet; the ingress packet becomes the egress packet.

When a network device forwards a packet to another sub-net (e.g., from 1.1.1.0/8 to 2.2.2.0/8), this is commonly referred to as “routing.” In a typical routing operation, the network device first checks to see if it was the intended recipient of the packet, as described above. If the destination MAC address in the packet matches the network device ‘s MAC address, the network device examines the destination IP address contained in the packet to determine where to send the packet; this process is generally referred to as looking up the next hop. The information that is generally used to look up the next hop includes the destination IP address, the destination MAC address, the source MAC address. The ingress packet can be modified: e.g., the layer 2 header information in the ingress packet can be replaced with a new Layer 2 header, the time to live (TTL) fields in the IP header can be decremented, the checksum recomputed, etc.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 is a system diagram that illustrates a router in accordance with the present disclosure.

FIG. 2 is a timing diagram that illustrates an Ethernet packet.

FIG. 3 shows details of a MAC address.

FIG. 4 is a high level representation of operations in a router to provide fast path processing in accordance with some embodiments of the present disclosure.

FIG. 5 is a high level representation of a crafted MAC address in accordance with some embodiments of the present disclosure.

FIG. 6 illustrates details of a lookup table in accordance with some embodiments of the present disclosure.

FIG. 7 is an illustrative example of fast path logic in accordance with some embodiments of the present disclosure.

FIG. 8 is a high level representation of operations in a router to select between fast path processing and slow path processing in accordance with some embodiments of the present disclosure.

FIG. 9 is a high level representation of fast path processing logic and slow path processing logic in accordance with some embodiments of the present disclosure.

FIG. 10 is a high level representation of operations to manage crafted MAC addresses in a router in accordance with some embodiments of the present disclosure.

FIG. 11 is a high level block diagram of a router configured to operate in accordance with the present disclosure.

### DETAILED DESCRIPTION

Latency is of critical importance in certain applications, such as financial markets for instance. Participants in the markets send messages via computer networks to effect orders, and the latency of those networks can be a key factor in the performance and profitability of their trading systems. Organizations that might try to optimize the performance of these systems include financial exchanges, financial traders, and service providers for that market. In financial trading systems, computers send orders (e.g., BUY, SELL, etc.) to the exchanges using Layer 3 networks in accordance with the routing process described above. The delay through that network (both on the exchange side and the trading side) can be critically important.

The present disclosure is directed to reducing routing latency in a router. In some time sensitive applications, such as trading systems, the speed at which a router makes routing decisions is particularly important. Reducing the delay of a network device’s routing decisions, if only on the order of tens of nanoseconds (ns), can be significantly beneficial.

Conventional (prior art) routers base their routing decisions on the destination IP address (DIP) contained in the ingress packet. An ingress packet (e.g., an Ethernet packet) arrives at the router in serial fashion as a bitstream. The DIP appears relatively deep into the bitstream; e.g., at 10 Gbps, the DIP is received at approximately 35.2 ns from the beginning of the packet.

A router in accordance with the present disclosure makes routing decisions based on the destination MAC (DMAC) contained in the ingress packet, instead of using the DIP. The DMAC appears earlier in time in the bitstream than does the DIP. For example, at 10 Gbps in a configuration where the bitstream is provided to the router logic in 32-bit words, the DMAC is fully received at about 12.8 ns from the beginning of the packet. In accordance with the present disclosure, information can be provided in a crafted DMAC by the downstream device that the router can use to make its routing decision. In some embodiments, for example, the information can be the last byte of the 6-byte datum that constitutes the DMAC, which can be used to do a lookup in the router’s routing tables to obtain routing information to produce an egress packet, including identifying on which interface to send the egress packet. In other embodiments, any portion of the DMAC (or its entirety) can be crafted and used by the router to inform the routing decision.

These crafted DMACs can be programmed (manually or by learning) into the routing tables of the downstream device; e.g., host, server, etc. When the downstream device builds an egress packet, the downstream device will use the crafted DMAC as the destination MAC address in the egress packet. The crafted DMAC is automatically selected per normal processing by virtue of having been programmed in the routing tables of the downstream device.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

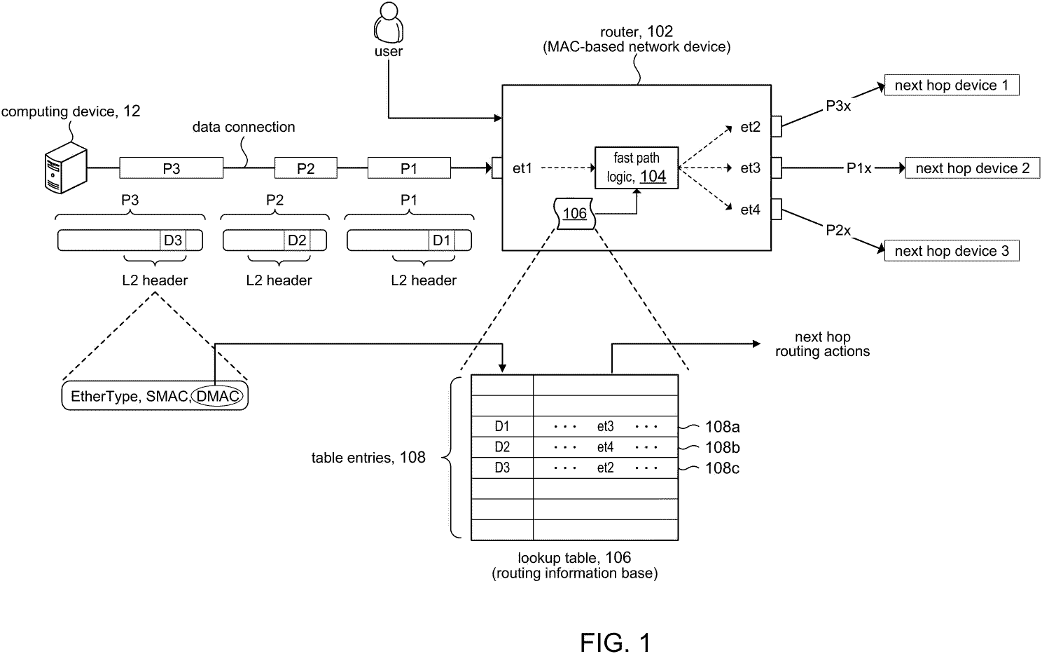

FIG. 1 shows an example of a network device (e.g., switch, router, etc.) in accordance with the present disclosure. FIG. 1, for example, shows a configuration comprising MAC-based router 102 (referred to herein simply as a router) in data communication with computing device 12. In some embodiments, the data connection between device 12 and router 102 can be a wired connection, as depicted in FIG. 1. Although not shown, in other embodiments the data connection can be wireless; e.g., via a wireless access point. Device 12 can be any configuration of computing device including, but not limited to, user computers (e.g., laptop computers, desktop computers, mobile computing devices, etc.), servers (e.g., database server, web server, media server, etc.), and so on.

In accordance with the present disclosure, router 102 can include fast path logic 104 to provide fast lookup processing to process and route ingress packets. Router 102 can include one or more lookup tables 106 to store a set of next hops and corresponding routing actions to inform the processing and routing of an ingress packet to its next hop. In some embodiments, lookup table 106 can be organized as a list of table entries 108. Each table entry can correspond to a next hop and include a DMAC data field and a routing actions data field. In accordance with some embodiments, table entries 108 can be indexed or otherwise accessed using the DMAC data field as an index key to access an entry comprising routing actions for the next hop. For discussion purposes, the examples described herein will use a lookup table data structure. It will be appreciated, however, that in other embodiments, lookup table 106 can be any suitable lookup data structure; e.g., a data tree.

The routing actions can include, among other data, information that identifies a port or interface (et1, et2, et3, et4) on which to send an egress packet for a given ingress packet to the next hop. It will be appreciated from the present disclosure that, in the more general case, the DMAC can be crafted to contain information to process an ingress packet in ways other than packet routing.

FIG. 1 illustrates an example of receiving and processing ingress packets in accordance with the present disclosure. In the example, device 12 sends packets P1, P2, P3 to router 102; first P1 is sent to router 102, then P2 is sent, then P3. In accordance with some embodiments, the packets are sent in accordance with Ethernet. In accordance with the present disclosure, router 102 can receive and process packets with Layer 2 (L2) headers that contain different DMAC addresses, even though they are sent to the same router. Fast path logic 104 can use the DMAC addresses contained in ingress packets P1, P2, P3 to determine corresponding next hops and routing actions from lookup table 106 with which to produce and route respective egress packets P1x, P2,x, P3x. For example, ingress packet P1 is routed as egress packet P1x over interface et3 (per entry 108a), packet P2 is routed as egress packet P2x over interface et4 (per entry 108b), and egress packet P3x is routed over interface et2 (per entry 108c).

Router 102 can be viewed as implementing multiple “virtual” routers, where each virtual router has its own MAC address, D1, D2, D3. Router 102 may be referred to as a “physical router” to distinguish router 102 from the virtual routers implemented in router 102. Each virtual router is connected to or otherwise associated with a single physical next hop device. For example, the virtual router addressed by D1 is connected to next hop device 1, the D2 virtual router is connected to next hop device 2, and the D3 virtual router is connected to next hop device 3. As can be seen in FIG. 1, the next hop devices are connected to respective physical interfaces of router 102; e.g., next hop device 1 is connected to interface et1 of router 102, next hop device 2 is connected to interface et2, and next hop device 3 is connected to et4.

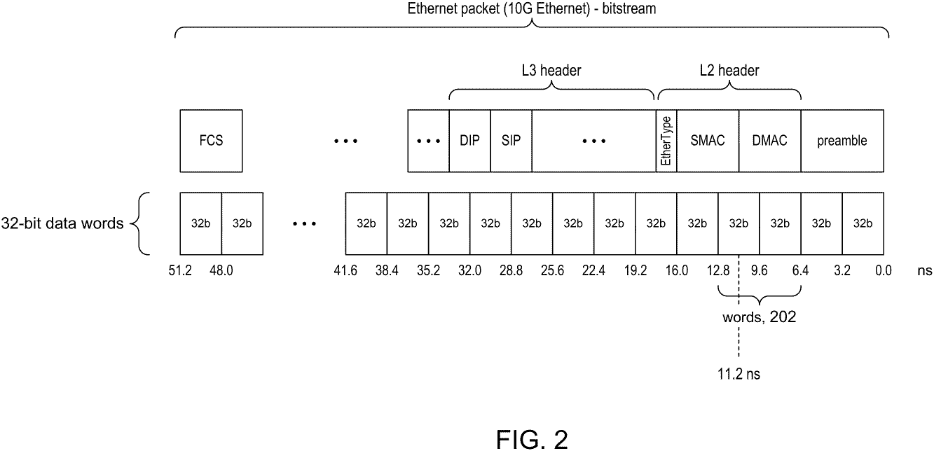

FIG. 2 shows timing details of a bitstream for a typical configuration of an Ethernet packet as it arrives in a network device such as router 102. It will be appreciated that for other configurations of Ethernet packets (e.g., L1 encoding and the like) the timings will be different. Further, it will be understood that all time values disclosed herein are approximate. The disclosed timings do not take into account signal propagation delays in the circuitry or variances that depend on the accuracy of the clock in a given implementation of the network device.

The timing and blocking is shown for 10 Gb Ethernet (10 gigabits per second, Gbps) with the understanding that the timing will be different for different data speeds. Timing for other data speeds can be readily determined; for example, the timings for 25 Gbps Ethernet, can be obtained by dividing the timing values shown in FIG. 2 by 2.5. For discussion purposes, the timings referenced herein will be with reference to the 10Gb Ethernet configuration of FIG. 2. The start time of an Ethernet packet will be deemed to occur with the arrival of the first bit of the Preamble, and the timings will be referenced to that start time. Further for purposes of discussion, as shown in FIG. 2, the Ethernet packet can be provided to fast path logic 104 in chunks or blocks of 32-bit words; for example, the first 32-bit word of the Ethernet packet can be provided to the fast path logic by 3.2 ns and the last 32-bit word of the Ethernet packet is provided to the fast path logic by 51.2 ns. It will be appreciated that other embodiments can employ word sizes other than 32 bits.

Ethernet is a well known, well understood, and well defined data transmission protocol. As shown in FIG. 2, when a network device (e.g., router 102) receives an Ethernet packet, the network device first receives a Preamble, followed by an L2 header, followed by an L3 header, and so on, and ends with a 32-bit frame check sequence (FCS); the other components of the Ethernet packet are omitted from this discussion. The Preamble and Start of Frame Delimiter (SFD) together typically occupy 64 bits on the wire. A specific implementation of Ethernet may use a shorter or longer Preamble and SFD in some or all cases, and it is understood that embodiments described herein can readily be adapted to such an implementation. The L2 header comprises a destination MAC address (DMAC), followed by a source MAC address (SMAC), and then an EtherType datum. The L3 header, among other data, includes a source IP address (SIP) followed by a destination IP address (DIP). The example shown in FIG. 2 is just one example of an Ethernet/IP packet. It will be appreciated that there can be other stacks of headers following the L2 header; e.g., one or more VLAN tags, etc. For the typical configuration of an Ethernet packet shown in FIG. 2, we can see that in some embodiments the DMAC address can be fully received by 11.2 ns after the start of the preamble. However, because the DMAC address is split across two 32-bit words 202, in an implementation that processes 32 bits at a time, the DMAC can be provided to the downstream logic (e.g., fast path logic 104) by 12.8 ns, after which time the downstream logic can extract the DMAC address from the two 32-bit words.

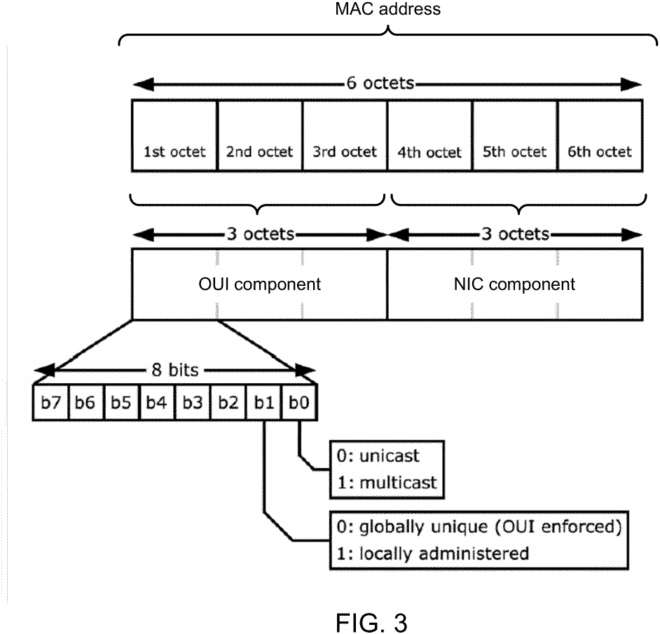

Referring to FIG. 3, details of a standard MAC address are shown. A MAC address generally identifies the physical interface in a network device. A MAC address comprises six octets (8-bit data). In the representation shown in FIG. 3, the first octet appears first in the bitstream, followed by the second octet, followed by the third octet, and so on. As shown in FIG. 2, for example, the first octet of the DMAC begins to arrive at 6.4 ns and the first octet of the SMAC begins to arrive at 11.2 ns.

The first three octets of a MAC address constitute an Organizationally Unique Identifier (OUI) part of the MAC address. Generally, the OUI is a universally unique code that is provided by the Institute of Electrical and Electronic Engineers (IEEE). The second three octets constitute a Network Interface Controller (NIC) identifier, which is typically assigned by the manufacturer of the interface. The first bit (least significant bit, b0) of the first octet indicates whether the MAC address is a unicast address or a multicast address. The second bit (bl) of the first octet indicates whether the MAC address is globally unique or is locally administered. In some embodiments, bit b1 in the OUI can be set to reduce the delay by an additional 3.2 ns. However, it is noted that this is a non-standard configuration and not all devices behave as expected with locally administered MAC’s.

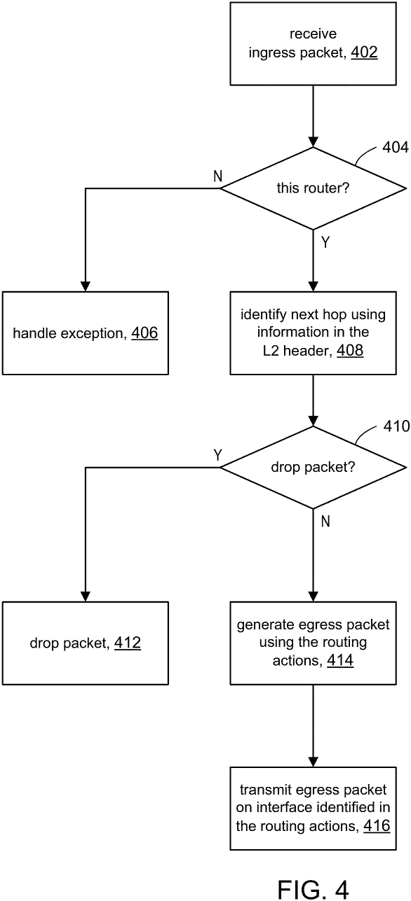

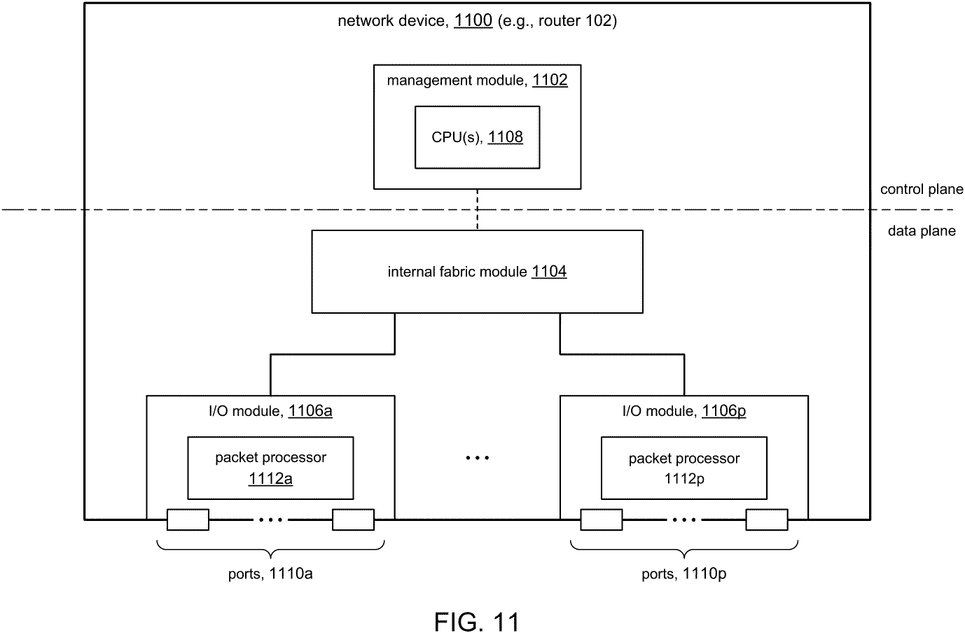

Referring to FIGS. 4, 5, and 6, the discussion will now turn to a high level description of operations and processing of fast path logic 104 in router 102 to process ingress packets in accordance with the present disclosure. In some embodiments, fast path logic 104 can comprise digital logic (e.g., implemented in a Field Programmable Gate Array, FPGA, or application-specific IC, ASIC) configured to perform processing in accordance with FIG. 4. In other embodiments, the fast path logic can comprise computer executable program code, which when executed by a processor in the router (e.g., 1108, FIG. 11), can cause the router to perform processing in accordance with FIG. 4. For discussion purposes, reference will be made to the 10 Gb Ethernet timings and word size as shown in FIG. 2 with the understanding that other data speeds and word sizes can be used.

At operation 402, the fast path logic can receive an ingress packet. In some embodiments, for example, the ingress packet can be an Ethernet packet received from a sending device (e.g., P1 and device 12, FIG. 1) as a bitstream (e.g., FIG. 2) on an interface of router 102. In some embodiments, the interface on router 102 that receives the ingress packet can be configured to provide the bitstream to the fast path logic in 32-bit data words as soon each data word is built-up so that the fast path logic can start processing the ingress packet in order to make a forwarding decision (including the proper egress port(s) and necessary packet modifications) before the entire packet is received; this is a known technique sometimes referred to as cut-through forwarding. For the 10 Gb Ethernet configuration shown in FIG. 2, the interface can provide the incoming bitstream to the fast path logic in 32-bit data words substantially every 3.2 ns. For example, the fast path logic can receive the first 32-bit data word substantially 3.2 ns after the router starts receiving the bitstream, the fast path logic can receive the second 32-bit data word substantially 3.2 ns after receiving the first 32-bit data word (at 6.4 ns), the fast path logic can receive the third 32-bit data word substantially 3.2 ns after that (at 9.6 ns), and so on. It will be understood that other Ethernet rates (1G, 25G, etc.) will have different timings. Note that the interface that delivers 32-bit data words may be an internal interface within a device. Data sent to it (or received from it) would undergo further transformation before being sent to (or after being received from) the physical transmission medium (e.g., optical fiber or copper cable).

A typical implementation of Ethernet includes multiple Physical layers between this word-at-a-time interface and the transmission (or reception) of signals on the physical medium. These Physical layers may perform encoding to and decoding from the electrical or optical signals on the physical medium, and in doing so convert them to or from a stream of bits corresponding to the contents of an Ethernet packet as presented to the Medium Access Layer. For implementation reasons, this stream of bits is delivered to and received from the Physical layer in groups of bits that are delivered in parallel. For instance, in 10 gb Ethernet the commonly-used XGMII interface to the Physical layer delivers 32 bit words to the Reconciliation Sublayer that then passes the data on to the Medium Access Control layer. In one embodiment the referenced interface of the device may correspond to a medium independent interface such as XGMII that sits between the Physical layer and the Medium Access Control layer. In some embodiments, the bits of the preamble and start of frame delimiter are not transmitted across this interface, but as a matter of terminology for discussion purposes we will say that the packet has “arrived” at the interface when the first bits of the preamble are ready to transmit from the Physical layer to this parallel interface.

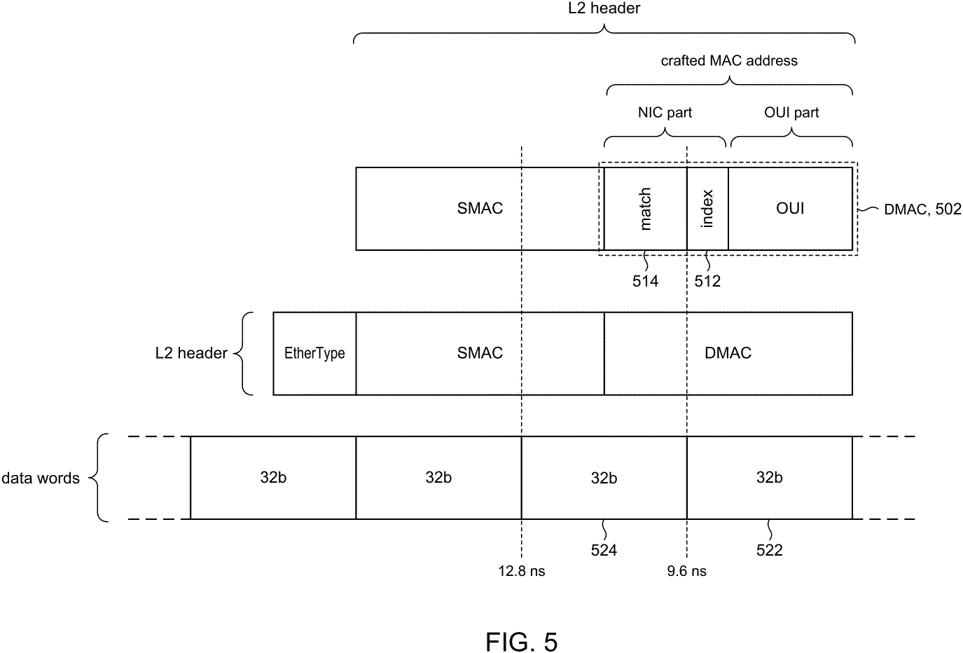

At operation 404, the fast path logic determines if the ingress packet is destined for this router. In accordance with the present disclosure, the fast path logic can use at least a portion of the DMAC address contained in the L2 header to determine if the ingress packet is destined for this router. Referring for a moment to FIG. 5, for instance, DMAC address 502 represents a MAC address that is crafted in accordance with some embodiments. For example, the OUI part of DMAC 502 can represent a 3-byte IEEE-assigned OUI described above, whereas the NIC part of DMAC 502 can be crafted to encode information including two-byte match value 514 and one-byte index component 512. FIG. 5 also shows timing information for receiving the OUI and NIC components of DMAC 502, based on the timing configuration shown in FIG. 2. For example, data word 522 contains the OUI part and index component 512, and can be provided to the fast path logic substantially 9.6 ns from when the Ethernet packet arrives at the interface of the router. Data word 524, containing match value 514 and a portion of the SMAC address can be provided to the fast path logic substantially 12.8 ns from when the Ethernet packet arrives at the interface.

In some embodiments, the OUI and match value can be static values that together identify this router as the destination of the ingress packet. Continuing with FIG. 4, if the ingress packet is destined for this router, vis-à-vis the OUI and match value, then processing can continue to operation 408. If the ingress packet is not destined for this router, the router can handle the exception at operation 406, for example, by dropping the packet.

At operation 408, the fast path logic can identify a next hop using the L2 header contained in the ingress packet. In accordance with the present disclosure, the fast path logic can use at least a portion of the DMAC address contained in the L2 header to identify the next hop device to which to route the ingress packet. In some embodiments, for example, the DMAC address can be crafted to encode look up information to identify the next hop in a lookup table. Referring again to FIG. 5, for example, in some embodiments, the fast path logic can use the index component (e.g., 512, FIG. 5) of the crafted DMAC as an index into the lookup table to identify an entry in the lookup table. The identified entry can contain information that identifies the next hop. In some embodiments, if the index component does not access a valid entry in the lookup table, the packet can be dropped.

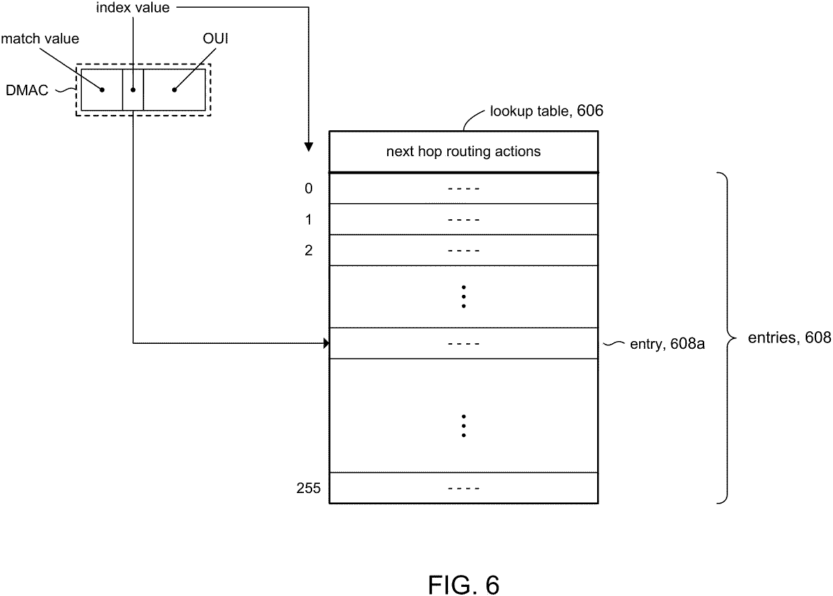

An example of the lookup process is illustrated in FIG. 6 with lookup table 606 comprising entries 608. The index component in the DMAC can be used to do an indexed lookup to identify entry 608a; e.g., for index component = n, the identified entry can be the n^{th} entry in lookup table 606. In some embodiments, the index component is an 8-bit value and so lookup table 606 may contain 256 entries corresponding to 256 next hops.

The routing actions in the identified entry can include information that identifies the next hop, such as a MAC address of the next hop device, the interface on which to route the packet to the next hop device, and so on. The routing actions can also inform the fast path logic how to prepare the ingress packet to be routed to the next hop; e.g. VLAN tagging, decrement TTLs, etc.

In some embodiments, if the received ingress packet cannot be routed, the router can take some appropriate action. For example, if the L3 header specifies an unknown route, the router can send an Internet Control Message Protocol (ICMP) redirect.

At decision point 410, when a next hop has been identified from the crafted DMAC, the fast path logic can prepare or otherwise process the ingress packet in accordance with the corresponding routing actions to generate or otherwise produce an egress packet. Merely to illustrate, routing actions can include, but are not limited to, actions and parameters such as:
routing decision
   o route packet or do not route packet
   o determine whether or not to route packet by further lookups; e.g., using source MAC or virtual local area network (VLAN) tag
egress port specifier - identifies the physical port on the router on which to send the egress packet
Layer 2 (L2) header rewrite parameters - one or more of the following L2 parameters in the ingress packet can be rewritten when generating the egress packet:
   o outgoing L2 source MAC address
   o outgoing L2 destination MAC address
   o outgoing L2 VLAN information
Layer 3 (L3) header rewrite parameters - one or more of the following L3 parameters in the ingress packet can be rewritten when generating the egress packet:
   o time-to-live (TTL) decrement
   o IP header checksum validation and update (e.g., for IPv4)
   o source or destination IP address rewrite (e.g. Network Address Translation)

If the routing actions associated with the identified next hop indicate to drop the ingress packet, then the fast path logic can drop the ingress packet at operation 412 and processing of the ingress packet can be deemed complete. In some embodiments, operation 412 can include logging or counting the fact of the dropped packet. If the identified routing actions do not indicate to drop the ingress packet, then processing can proceed to operation 414.

At operation 414, the fast path logic can process the ingress packet in accordance with the routing actions to generate or otherwise produce an egress packet. In accordance with the present disclosure, the fast path logic can rewrite portions of the ingress packet based on the routing actions to produce the egress packet. The fast path logic can begin to identify the next hop and corresponding routing actions for the egress packet as soon as the fast path logic receives the data words (e.g., 522, 524, FIG. 5) that comprise the crafted DMAC. Using the timing configuration of FIG. 2, for example, the data words can be provided to the fast path logic substantially 12.8 ns from the start of the ingress packet, as the rest of the bitstream comprising the ingress packet continues to arrive at the router. Accordingly, the fast path logic can start to rewrite portions of the ingress packet substantially 12.8 ns from the start of the ingress packet using information comprising the identified routing actions to produce the L2 header for the egress packet. Processing of the ingress packet by the fast path logic can be deemed complete. It will be understood that additional logic (not shown) in the router can perform additional processing/rewrites on the ingress packet to produce the egress packet.

At operation 416, the router can transmit the egress packet on an interface of the router that is identified in the routing actions to route the egress packet to the next hop.

It was noted above that router 102 can be viewed as implementing multiple virtual routers. As described in connection with FIG. 5, the static component of the DMAC address (OUI and match value) contained in an ingress packet can be used to determine that the ingress packet is destined for this router; in other words a router in accordance with the present disclosure can accept any DMAC address that contains a given OUI/match value pair. The router uses the 8-bit index component to identify a specific next hop. Thus, for a given OUI/match value pair, the 8-bit index component gives us 256 possible DMAC addresses that the router can accept. In this way, the router can be viewed as being 256 virtual routers and more specifically 256 single-hop virtual routers. In some embodiments, one of the virtual routers can be associated with slow path logic. This aspect of the present disclosure is discussed below.

It will be appreciated that the DMAC encoding shown in FIG. 5 represents one of several embodiments for encoding a DMAC in accordance with the present disclosure. In other embodiments, the number of bits allocated between the match value and the index component can be varied. In some embodiments, one or more OUI’s can be incorporated. In some embodiments, a hash of the DMAC can be used to identify the next hop, for example, to avoid the need for a contiguous block. In some embodiments, a portion of the next hop’s DMAC address can be incorporated in the crafted DMAC itself; e.g., when routing to a number of routers in a single sub-domain, the table lookup can be avoided by directly using the value in the DMAC.

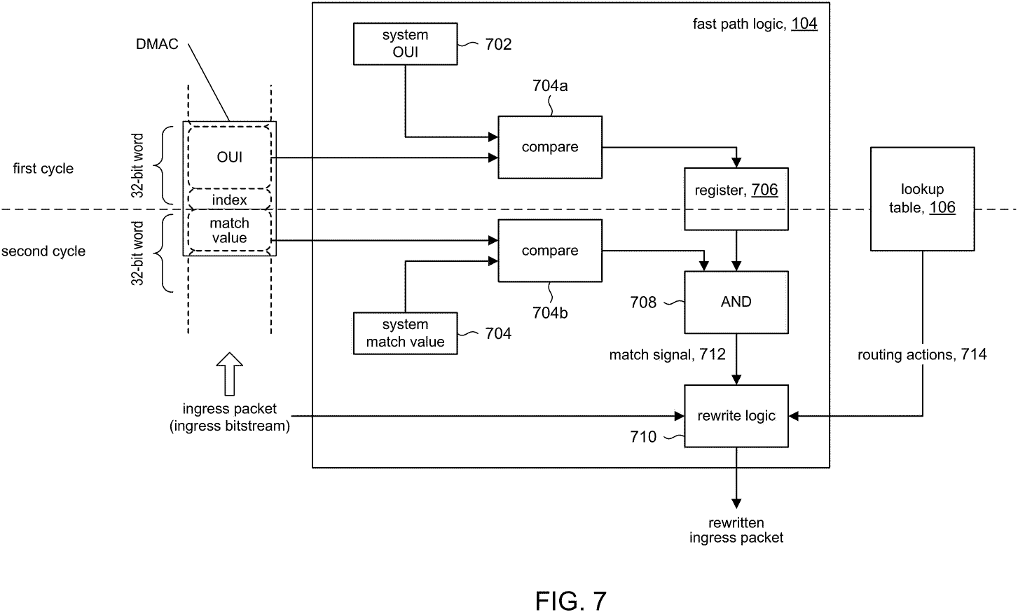

FIG. 7 shows a diagrammatic representation of fast path logic 104 in accordance with some embodiments of the present disclosure. As noted above, in some embodiments, fast path logic 104 can receive the ingress packet bitstream on a data bus (not shown) as 32-bit data words. In some embodiments, fast path logic 104 can include system OUI data store 702 and system match value data store 704. As noted above the OUI is managed by the IEEE and identifies the manufacturer of the physical interface. System OUI data store 702 and system match value data store 704 can be data stored in a suitable non-volatile memory.

Comparator 704a can provide a bitwise comparison between the system OUI and the OUI portion of the DMAC address of ingress packet. Comparator 704b, likewise, can provide a similar bitwise comparison between the system match value and the match value that is encoded in the DMAC address. The output of comparators 704a, 704b feed into AND gate 708. The output of AND gate 708 is match signal 712. The match signal is set (e.g., logic ‘1’) when the OUI and the match value portions of the DMAC address match the respective system OUI and system match values. Register 706 serves to delay the output of comparator 704a to AND gate 708 by one bus cycle because the OUI and the match value from the bitstream are provided to the fast path logic 104 in separate data words; comparator 704a receives the OUI on a first bus cycle while comparator 704b receives the match value on the next bus cycle.

Fast path logic 104 can use the index component that is encoded in the DMAC address as an index into lookup table 106 to access routing actions 714, for example, as shown in FIG. 6. In some embodiments, the index component can be provided to lookup table 106 on the first bus cycle, as soon as the fast path logic receives the data word containing the index component.

Rewrite logic 710 can use match signal 712 as a trigger to rewrite the ingress packet L2 header, as the header data is presented to it using the accessed routing actions 714 to produce a rewritten ingress packet. It will be appreciated that in some embodiments, router 102 may perform additional rewrites on the ingress packet downstream of fast path logic 104 to produce an egress packet.

As explained, the present disclosure identifies egress information for routing an ingress packet to a next hop device using the DMAC address contained in the L2 header of the ingress packet. Using the configuration shown in FIG. 2 as an example, the DMAC address in the L2 header of the ingress packet arrives substantially 11.2 ns from the beginning of the bitstream that comprises the ingress packet. The egress information such as egress port, destination MAC, etc. can be determined substantially 12.8 ns from the beginning of the ingress bitstream, when the fast path logic receives the two data words (e.g., 522, 524, FIG. 5) that contain the DMAC address. Accordingly, transmission of an egress packet in accordance with the present disclosure can begin substantially 12.8 ns from the beginning of the ingress bitstream when using cut-through switching. By comparison, egress information based on the L3 header of the ingress packet does not become known until substantially 32 ns from the beginning of the bitstream, reducing the latency in producing an egress packet by about 40%.

The part of the ingress packet that determines the next hop is in the first 32 bits of the L2 header. This allows for the next hop to be determined significantly earlier than if the next hop was based on the L3 header. The entire egress L2 header (14+ bytes, received in 4x 32 bit words) can be determined when the first two 32-bit words of the L2 header are received.

Fast path logic in accordance with the present disclosure can do a direct (indexed) lookup on a small table, instead of performing a conventional full match (slow path) search for a match in a large possibility of matches. In accordance with some embodiments, for example, the one-byte index component (e.g., 512, FIG. 5) in the crafted DMAC identifies a next hop by simply indexing into a lookup table to access the i^{th} entry in the lookup table. By comparison, a conventional full match lookup identifies the next hop information in a lookup table by performing a match of information (e.g., four-byte field of the destination IP) in the L3 header on the contents of the lookup table (e.g., a content-addressable memory, CAM, trie, ternary CAM, and the like).

The fast path logic is simpler than the logic used to perform full match lookups on a four-byte field. The logic itself is simpler; the lookup operation only involves indexing into a table. In some embodiments, where the index component is a one-byte value, the lookup table itself is small. The reduced size of the fast path logic allows for the logic to be replicated on a per-ingress-port basis rather than having to share the logic between multiple ports as in the case of conventional full match processing.

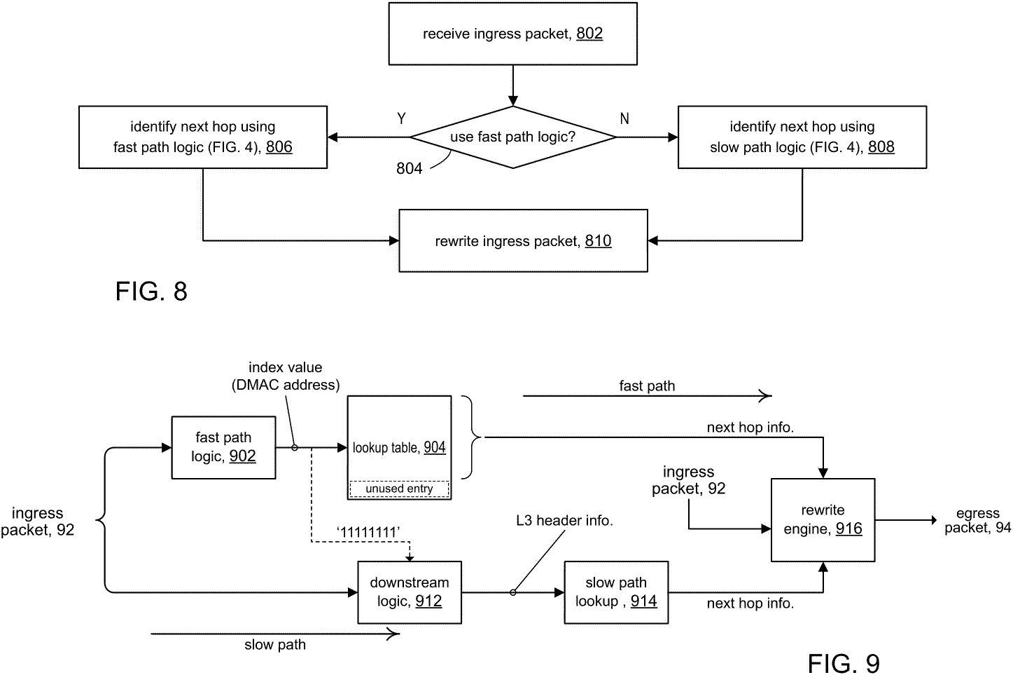

Referring to FIG. 8, a router (e.g., 102) in accordance with some embodiments can selectively route packets using fast path logic or slow path logic (e.g., full match processing). As discussed above, fast path logic is generally simpler than conventional full match processing. However, the simpler design comes at the cost of a small lookup table for next hop devices in order to keep the size of the fast path logic reasonable as compared to the larger content addressable memory used with conventional full match processing. In some embodiments, the selective routing of packets can be used for important or critical next hops to be selected using fast path logic, while at the same time being able to accommodate a much larger number of noncritical next hops using slow path logic such as conventional full match processing.

FIG. 8 illustrates a high level description of operations and processing in router 102 to selectively process ingress packets using fast path logic (e.g., 104, FIG. 1) in accordance with some embodiments. In some embodiments, the router can comprise digital logic (e.g., implemented in a Field Programmable Gate Array, FPGA, or application-specific IC, ASIC) configured to perform processing in accordance with FIG. 8. In other embodiments, the fast path logic can comprise computer executable program code, which when executed by a processor in the router (e.g., 1108, FIG. 11), can cause the router to perform processing in accordance with FIG. 8.

At operation 802, the fast path logic can receive an ingress packet. In accordance with some embodiments, for example, the bitstream that comprises the ingress packet can be provided to the fast path logic. As described above in connection with operation 402 in FIG. 4, the fast path logic can receive the bitstream in units of 32-bit words. Processing continues when the fast path logic receives the DMAC address in the L2 header of the ingress packet.

At decision point 804, if a determination is made to continue processing the ingress packet using fast path logic, then processing can proceed to operation 806. If the determination is made to process the ingress packet using slow path logic, then processing can proceed to operation 808. In some embodiments, the value of the index component (e.g., 512, FIG. 5) in the DMAC address can be set to a predetermined value to indicate using slow path logic. Accordingly, for a one-byte (8-bit) index component, the index can be set to 255 as a signal to use slow path logic.

At operation 806, when a determination is made to use fast path logic, information contained in the L2 header of the ingress packet can be used to access information for the next hop; e.g., as described in FIG. 4.

At operation 808, when a determination is made to use slow path logic, information for the next hop can be accessed using alternative lookup strategies that are not optimized for one or both of high throughput or low latency. The slow path logic may, for instance, be optimized for high scale in terms of number of prefixes in the table, for small size (by sharing logic), for large number of next hops, or for complex rewrite actions such as tunneling.

At operation 810, the router can use the accessed next hop information (operation 806, 808) to rewrite the ingress packet to produce an egress packet. For an Ethernet/IP packet, for instance, the source and destination MAC addresses can be updated; e.g., the source MAC address can be set to a MAC address of the router, the destination MAC address can be set to the MAC address of the next hop. The source and destination IP addresses can be similarly updated, the TTL can be decremented, and so on. It is noted that the entire L2 header is updated at this point, which means that the entire egress L2 header is determined as soon as the router looks up the DMAC. This equates to being able to transmit more of the packet than has already been received. This “recovered” delay can be used to mask other sources of delay that are incurred during the process of routing the packet.

FIG. 9 shows a high level block diagram of logic that functions in accordance with FIG. 8. Ingress packet 92 can be initially processed by fast path logic 902 to perform a lookup on lookup table 904; e.g., using an 8-bit index component in the DMAC address of the ingress packet. In this example, an index component equal to binary 111111111 (decimal 255) indicates using slow path logic.

Accordingly, an index value other than 255 will be processed according to the fast path logic. More specifically, the index value can be used to do an indexed lookup in lookup table 904 to produce information for the next hop as soon as the DMAC address in the L2 header arrives.

An index value of 255 can trigger downstream logic 912 to perform slow path processing to look up the next hop information. Because high throughput or low latency is not a concern, slow path logic 914 can use logic to perform next hop lookups that would not be suitable in the fast path. For an Ethernet/IP ingress packet, slow path processing can use the L3 (IP) header of the ingress packet, which requires waiting for the L3 header information to arrive, to do a next hop lookup. In some embodiments, slow path lookup logic 914 can be a CAM or a ternary CAM (TCAM). The next hop lookup can be made by doing a full path match on the CAM using the L3 header information. It will be appreciated that slow path lookup logic 914, being slow path, can use lookup techniques that would not be appropriate for the fast path. For example, in some embodiments, slow path lookup logic 914 can be a general CPU. The CPU can be programmed to perform a next hop lookup in a table stored in memory; e.g. a hash-based lookup.

The next hop information can be provided to rewrite engine 916 to rewrite portions of ingress packet 92 to produce egress packet 94. Rewrites can include updating the L2 and L3 headers (e.g., IP addresses, TTL, etc.). The egress packet can then be further processed by additional downstream logic and subsequently transmitted on the next hop. In some embodiments, rewrite engine 916 may have different rewrite logic for the fast path and for the slow path.

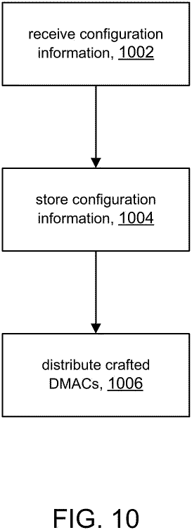

Referring to FIG. 10, the discussion will now turn to a high-level description of operations and processing in a router (e.g., router 102, FIG. 1) to manage crafted MAC addresses (FIG. 5) in accordance with the present disclosure. In some embodiments, router 102 can comprise computer executable program code, which when executed by a processor in the router (e.g., 1108, FIG. 1 1), can cause the router to perform processing in accordance with FIG. 10.

At operation 1002, router 102 can receive configuration information to configure a virtual router. Recall from FIG. 1 above that router 102, in accordance with some embodiments, can be viewed as implementing multiple virtual routers. In accordance with some embodiments, the configuration information for a virtual router can include a crafted MAC address (e.g., FIG. 5) and corresponding routing actions. The virtual router is associated with a physical next hop device (e.g., next hop device 1, FIG. 1) and the routing action includes, among other information (e.g., VLAN ID, IP addresses, etc.), information that identifies the physical interface on router 102 to which that next hop device is connected. Referring to the configuration in FIG. 1, for example, configuration information can be provided to configure a virtual router in router 102 that has a MAC address D1 and routing actions that specify, among other things, next hop device 1 as the next hop for the virtual router and physical interface et2 (the interface to which next hop device 1 is connected).

At operation 1004, router 102 can store the received configuration information into a lookup table (e.g., 606, FIG. 6). For example, router 102 can use the index component (512, FIG. 5) in the crafted MAC address contained in the configuration information to identify the entry in the lookup table to store the received routing information. In some embodiments, the user can specify the index component; e.g., setting the index component to k will cause router 102 to store the routing information in the k^{th} entry in the lookup table. In other embodiments, router 102 itself can compute a suitable index component for the crafted MAC address contained in the configuration information. Router 102 can store the configuration information in an entry in the lookup table according to the index component in the crafted MAC address.

At operation 1006, router 102 can distribute the crafted MAC addresses to computing devices (e.g., 12, FIG. 1) in the network. Any of a number of known and well understood protocols can be used to distribute the crafted MAC addresses. In some embodiments, for example, router 102 can use the Border Gateway Protocol (BGP). As explained above, each crafted MAC address corresponds to a virtual router implemented by router 102. An IP address can be assigned to each virtual router (e.g., via its configuration information). Router 102 can use BGP to advertise those IP addresses to computing devices in the network. A computing device can then use the Address Resolution Protocol (ARP) to communicate with router 102 to learn the MAC addresses, namely the crafted MAC addresses, of those IP addresses from router 102.

In other embodiments, router 102 can use Internet Control Message Protocol (ICMP). ICMP provides a facility referred to as “ICMP re-directs” that can inform an endpoint (e.g., computing device 12, FIG. 1) of a better router on the L2 network for its destination. For example, if router 102 receives a packet from a computing device at a “slow path” MAC address (FIG. 9), and the packet matches a next hop which has a crafted MAC address (i.e., has a fast path to that next hop), then router 102 can route the packet to the destination, and then send an ICMP re-direct to the computing device to inform the computing device of the better router address to use. The computing device, if configured to accept ICMP redirect messages, would then update its routing table to send packets for that next-hop to the crafted MAC address.

In other embodiments, proxy-ARP can be used where the computing device can treat the virtual routers as being on its local L2 network, and use ARP to learn the crafted MAC addresses of the virtual routers.

In some embodiments, other routing protocol advertisements can be used, such as Routing Information Protocol (RIP), Open Shortest Path First (OSPF), IPV6 Router Advertisement, etc.

FIG. 11 depicts an example of a network device 1100 in accordance with some embodiments of the present disclosure. In some embodiments, network device 1100 can be a switch (e.g., router 102, FIG. 1). As shown, network device 1100 includes a management module 1102, an internal fabric module 1104, and a number of I/O modules 1106a - 1106p. Management module 1102 includes the control plane (also referred to as control layer) of network device 1100 and can include one or more management CPUs 1108 for managing and controlling operation of network device 1100 in accordance with the present disclosure. Each management CPU 1108 can be a general purpose processor, such as but not limited to an Intel®/AMD® x86 or ARM® processor, that operates under the control of software stored in a memory (not shown), such as dynamic random access memory (DRAM). Control plane refers to all the functions and processes that determine which path to use, such as routing protocols, spanning tree, and the like.

Internal fabric module 1104 and I/O modules 1106a - 1106p collectively represent the data plane of network device 1100 (also referred to as data layer, forwarding plane, etc.). Internal fabric module 1104 is configured to interconnect the various other modules of network device 1100. Each I/O module 1106a - 1106p includes one or more input/output ports 1110a - 11 lOp that are used by network device 1100 to send and receive network packets. Each I/O module 1106a - 1106p can also include a packet processor 1112a - 1112p. Each packet processor 1112a - 1112p can comprise a forwarding hardware component (e.g., application specific integrated circuit (ASIC), field programmable gate array (FPGA), content-addressable memory, and the like) configured to support wire speed decisions on how to handle incoming (ingress) and outgoing (egress) network packets. In accordance with some embodiments some aspects of the present disclosure can be performed wholly within the data plane.

### Further Examples

In accordance with the present disclosure, a method includes receiving, by a first network device, an ingress data packet comprising a Layer 2 (L2) header that includes a destination media access control (MAC) address; identifying, by the first network device, one or more bits comprising the destination MAC address of the ingress data packet; using, by the first device, the one or more bits to access an entry in a lookup data structure comprising a plurality of routing actions, wherein the accessed entry corresponds to accessed routing actions; generating, by the first device, an egress data packet from the ingress data packet based on the accessed routing actions; identifying, by the first device, a first egress interface based on the accessed routing actions; and sending, by the first device, the egress data packet out of the first egress interface.

In some embodiments, the one or more bits comprising the destination MAC address are a subset of the destination MAC address.

In some embodiments, generating the egress data packet includes rewriting one or more of a destination MAC address, a source MAC address of the ingress data packet, and an Internet protocol (IP) header of the ingress data packet based on the accessed routing actions.

In some embodiments, the first egress interface is identified based only on the accessed routing actions.

In some embodiments, the method further includes receiving a subsequent ingress data packet; identifying a second egress interface using an IP address contained in the subsequent ingress data packet; and sending an egress packet generated from the subsequent ingress data packet out of the second egress interface.

In some embodiments, the method further includes the first network device providing the destination MAC address to a sender of the ingress data packet prior to the sender sending the ingress data packet.

In some embodiments, the L2 header conforms to Ethernet.

In accordance with the present disclosure, a network device includes a plurality of interfaces; one or more computer processors; and a computer-readable storage medium comprising instructions for controlling the one or more computer processors to identify packet routing actions for an ingress packet using only information contained in a Layer 2 (L2) header of the ingress packet; produce an egress packet by modifying the ingress packet using the identified packet routing actions; and send the egress packet on one of the plurality of interfaces specified in the identified packet routing actions.

In some embodiments, the packet routing actions are identified using only a destination MAC (DMAC) address contained in the L2 header of the ingress packet.

In some embodiments, the computer-readable storage medium further comprises instructions for controlling the one or more computer processors to receive a bitstream that comprises the ingress packet, wherein the packet routing actions are identified in response to receiving a plurality of bits of the bitstream that constitutes at most a portion of the L2 header.

In some embodiments, the network device further includes a routing information base comprising plurality of entries, and the computer-readable storage medium further comprises instructions for controlling the one or more computer processors to use the portion of the L2 header as index into the routing information base to access an entry that contains the packet routing actions.

In some embodiments, the computer-readable storage medium further comprises instructions for controlling the one or more computer processors to identify the packet routing actions as soon as a first portion of the L2 header is received.

In some embodiments, the computer-readable storage medium further comprises instructions for controlling the one or more computer processors to identify the packet routing actions prior to receiving the entirety of a destination IP address contained in the ingress packet.

In some embodiments, the routing actions includes one or more one of: modifying a source MAC address contained in the L2 header, modifying a destination MAC address contained in the L2 header, and modifying a Layer 3 header contained in the ingress packet.

In some embodiments, the computer-readable storage medium further comprises instructions for controlling the one or more computer processors to receive a second ingress packet and to trigger routing of the second ingress packet using information contained in a Layer 3 header of the second ingress packet based on information contained in the L2 header of the second ingress packet.

In accordance with the present disclosure, a method in a network device includes receiving a bitstream comprising an ingress packet; in response to receiving a first plurality of bits comprising a portion of an L2 header of the ingress packet, identifying routing actions using the first plurality of bits; rewriting the ingress packet using at least information contained the identified routing actions; and egressing the rewritten ingress packet on a physical interface of the network device specified in the identified routing actions.

In some embodiments, the portion of an L2 header of the ingress packet is a DMAC address. In some embodiments, the first plurality of bits comprise a portion of the DMAC address.

In some embodiments, identifying routing actions includes indexing into a lookup table using the first plurality of bits as an index into the lookup table to access an entry in the lookup table, wherein the routing actions are stored in the accessed entry.

In some embodiments, the method further includes receiving a second ingress packet; and egressing the second ingress packet using information contained in an L3 header of the second ingress packet based on information contained in the L2 header of the second ingress packet.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method comprising:
receiving, by a first network device, an ingress data packet comprising a Layer 2 (L2) header that includes a destination media access control (MAC) address;
identifying, by the first network device, one or more bits comprising the destination MAC address of the ingress data packet;
using, by the first device, the one or more bits to access an entry in a lookup data structure comprising a plurality of routing actions, wherein the accessed entry corresponds to accessed routing actions;
generating, by the first device, an egress data packet from the ingress data packet based on the accessed routing actions;
identifying, by the first device, a first egress interface based on the accessed routing actions; and
sending, by the first device, the egress data packet out of the first egress interface.

2. The method of claim 1, wherein the one or more bits comprising the destination MAC address are a subset of the destination MAC address.

3. The method of claim 1, wherein generating the egress data packet includes rewriting one or more of a destination MAC address, a source MAC address of the ingress data packet, and an Internet protocol (IP) header of the ingress data packet based on the accessed routing actions.

4. The method of claim 1, wherein the first egress interface is identified based only on the accessed routing actions.

5. The method of claim 1, further comprising:
receiving a subsequent ingress data packet;
identifying a second egress interface using an IP address contained in the subsequent ingress data packet; and
sending an egress packet generated from the subsequent ingress data packet out of the second egress interface.

6. The method of claim 1, further comprising the first network device providing the destination MAC address to a sender of the ingress data packet prior to the sender sending the ingress data packet.

7. The method of claim 1, wherein the L2 header conforms to Ethernet.

8. A network device comprising:
a plurality of interfaces;
one or more computer processors; and
a computer-readable storage medium comprising instructions for controlling the one or more computer processors to:
identify packet routing actions for an ingress packet using only information contained in a Layer 2 (L2) header of the ingress packet;
produce an egress packet by modifying the ingress packet using the identified packet routing actions; and
send the egress packet on one of the plurality of interfaces specified in the identified packet routing actions.

9. The network device of claim 8, wherein the packet routing actions are identified using only a destination MAC (DMAC) address contained in the L2 header of the ingress packet.

10. The network device of claim 8, wherein the computer-readable storage medium further comprises instructions for controlling the one or more computer processors to receive a bitstream that comprises the ingress packet, wherein the packet routing actions are identified in response to receiving a plurality of bits of the bitstream that constitutes at most a portion of the L2 header.

11. The network device of claim 10, further comprising a routing information base comprising plurality of entries, wherein the computer-readable storage medium further comprises instructions for controlling the one or more computer processors to use the portion of the L2 header as index into the routing information base to access an entry that contains the packet routing actions.

12. The network device of claim 8, wherein the computer-readable storage medium further comprises instructions for controlling the one or more computer processors to identify the packet routing actions as soon as a first portion of the L2 header is received.

13. The network device of claim 8, wherein the computer-readable storage medium further comprises instructions for controlling the one or more computer processors to identify the packet routing actions prior to receiving the entirety of a destination IP address contained in the ingress packet.

14. The network device of claim 8, wherein the routing actions includes one or more one of: modifying a source MAC address contained in the L2 header, modifying a destination MAC address contained in the L2 header, and modifying a Layer 3 header contained in the ingress packet.

15. The network device of claim 8, wherein the computer-readable storage medium further comprises instructions for controlling the one or more computer processors to receive a second ingress packet and to trigger routing of the second ingress packet using information contained in a Layer 3 header of the second ingress packet based on information contained in the L2 header of the second ingress packet.

16. A method in a network device comprising:
receiving a bitstream comprising an ingress packet;
in response to receiving a first plurality of bits comprising a portion of an L2 header of the ingress packet, identifying routing actions using the first plurality of bits;
rewriting the ingress packet using at least information contained the identified routing actions; and
egressing the rewritten ingress packet on a physical interface of the network device specified in the identified routing actions.

17. The method of claim 16, wherein the portion of an L2 header of the ingress packet is a DMAC address.

18. The method of claim 17, wherein the first plurality of bits comprise a portion of the DMAC address.

19. The method of claim 16, wherein identifying routing actions includes indexing into a lookup table using the first plurality of bits as an index into the lookup table to access an entry in the lookup table, wherein the routing actions are stored in the accessed entry.

20. The method of claim 16, further comprising:
receiving a second ingress packet; and
egressing the second ingress packet using information contained in an L3 header of the second ingress packet based on information contained in the L2 header of the second ingress packet.
